(19) United States
(12) Patent Application Publication
(10) Pub. No.: US 2014/0123049 A1
(43) Pub. Date: May 1, 2014

(54) KEYBOARD WITH GESTURE-REDUNDANT KEYS REMOVED

(71) Applicant: MICROSOFT CORPORATION, Redmond, WA (US)

(72) Inventors: William A. S. Buxton, Toronto (CA); Ahmed Sabbir Arif, Toronto (CA); Michel Pahud, Kirkland, WA (US); Kenneth P. Hinckley, Redmond, WA (US); Finbarr S. Duggan, Bray (IE)

(73) Assignee: MICROSOFT CORPORATION, Redmond, WA (US)

(21) Appl. No.: 13/720,527

(22) Filed: Dec. 19, 2012

Related U.S. Application Data
(60) Provisional application No. 61/720,335, filed on Oct. 30, 2012.

(51) Int. Cl. G06F 3/0488

(52) U.S. Cl. CPC G06F 3/04886
USPC 715/773

(57) ABSTRACT

The subject disclosure is directed towards a graphical or printed keyboard having keys removed, in which the removed keys are those made redundant by gesture input. For example, a graphical or printed keyboard may be the same overall size and have the same key sizes as other graphical or printed keyboards with no numeric keys, yet via the removed keys may fit numeric and alphabetic keys into the same footprint. Also described is having three or more characters per key, with a tap corresponding to one character, and different gestures on the key differentiating among the other characters.

### BACKGROUND

Finger or stylus-operated graphical touch-screen keyboards (sometimes referred to as virtual keyboards and digital keyboards) present some challenging design problems, especially on small form-factors such as a mobile phone. The small form factor means that screen real-estate is limited, especially when using a graphical keyboard, because the keyboard and application are competing for screen real-estate.

From the perspective of the keyboard, the designer is confronted by a number of tradeoffs. For a given footprint, the designer has to make a choice between more but smaller keys, or fewer but bigger keys. Having more keys on a keyboard means less expensive hopping/time-consuming navigation from one graphical keyboard (e.g., the primary) to another graphical keyboard (e.g., the secondary or tertiary keyboard character sets and so on). However the potential to reduce the size of the keys in order to present the additional keys from other keyboards is very limited, because the smaller the keys, the harder it is for users to accurately tap the desired key in a timely manner.

As a result, the keys can only be shrunk to a reasonable size, whereby designs typically resort to limiting the number of keys available at any one time, and employing a multiple-keyboard strategy. Moving from keyboard to keyboard imposes extra burden on the user, in terms of time-motion (i.e., hand movement and keystrokes to navigate from one to the other) as well as cognitive (i.e., remembering where characters are located and/or searching for them). There is additional cognitive load imposed by the disruption of flow and disruption in the context, and the associated need to assimilate the new menu—as well as the cost of switching back to the standard keyboard when finished.

Thus, access to the full character set comes at the cost of user overhead in switching from keyboard to keyboard, knowing (or hunting for) which keyboard contains the character or characters needed to be entered, and the disruption of attention and working memory imposed by switching contexts. As one example, there are four separate graphical keyboards used in one mobile smartphone device, including a main alphabetic keyboard, an emoticon keyboard, a first numeric/special character keyboard and a second numeric/special character keyboard.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology in which a graphical or printed keyboard is provided on a touch-sensitive surface at which tap input and gesture input is received. The keyboard is configured with a removed key set comprising at least one removed or substantially removed key, in which each key of the removed key set corresponds to a character, action, or command code that is enterable via a gesture.

In one aspect, a keyboard is provided, in which the keyboard includes alphabetic keys and numeric keys in a same-sized or substantially same-sized touch-sensitive area relative to a different keyboard that includes alphabetic keys and does not include numeric keys, and in which the keyboard and the different keyboard have same-sized or substantially same-sized alphabetic keys. The keyboard is provided by removing one or more keys from the keyboard that are made redundant by gesture input.

In one aspect, there is described receiving data corresponding to interaction with a key of a keyboard, in which at least one key represents at least three characters (including letters, numbers, special characters and/or commands). If the data indicates that the interaction represents a first gesture, a first character value is output. If the data indicates that the interaction represents a second gesture (that is different from the first gesture), a second character value is output. If the data indicates that the interaction represents a tap, a tap-related character value represented by the key may be output.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram including components configured to provide a keyboard with gesture-redundant keys removed and capable of having a virtual touchpad, according to one example embodiment.

FIG. 2 is a representation of a keyboard with gesture-redundant keys removed, according to one example embodiment.

FIG. 3 is a representation of the keyboard of FIG. 2 showing how gestures that replace the removed keys may be used, according to one example embodiment

FIG. 4 is a representation of a keyboard in which one or more keys may have represent more than two available characters, with a tap and different gestures differentiating among the available characters, according to one example embodiment.

FIGS. 5A and 5B are representations of a graphical keyboard with gesture-redundant keys removed, in which only some keys change to provide different characters, according to one example embodiment.

FIG. 6 is a representation of a graphical keyboard in which emoticon characters may be made available by interaction with another keyboard, according to one example embodiment.

FIG. 7 is a representation of an alternative keyboard in which one or more keys may represent more than two available characters, with a tap and different gestures differentiating among the available characters, according to one example embodiment.

FIG. 8 is a representation of a keyboard with gesture-redundant keys removed, in which different gesture regions are provided, according to one example embodiment.

FIG. 9 is a representation of a keyboard with a virtual touchpad for editing provided, including cursor keys for cursor movement, according to one example embodiment.

FIG. 10 is a representation of a keyboard with a virtual touchpad for editing provided, including a pointer entry area, according to one example embodiment.

FIGS. 11 and 12 comprise a flow diagram showing how various tap and gesture input may be handled on keyboards, according to one example embodiment.

FIGS. 13 and 14 are representation of alternative keyboards in which one or more keys may represent more than two available characters, with a tap and different gestures differentiating among the available characters, according to one example embodiment.

FIG. 15 is a block diagram representing an example computing environment, in the example of a computing device, into which aspects of the subject matter described herein may be incorporated

### DETAILED DESCRIPTION

Various aspects of the technology described herein are generally directed towards a touch-sensitive graphical or printed keyboard technology in which gestures replace certain keys on the keyboard, e.g., those that are made unnecessary (that is, made otherwise redundant) by the gestures. The removal of otherwise redundant keys allows providing more keys on the provided keyboard in the same touch-sensitive real estate, providing larger keys in the same touch-sensitive real estate, and/or reducing the amount of touch-sensitive real estate consumed by the keyboard. Note that as used herein, a “graphical” keyboard is one that is rendered on a touch-sensitive display surface, and can therefore programmatically change its appearance. A “printed” keyboard is one associated with a pressure sensitive surface or the like (e.g., built into the cover of a slate computing device) that is not programmatically changeable in appearance, e.g., a keyboard printed, embossed, physically overlaid as a template or otherwise affixed or part of a pressure sensitive surface. As will be understood, the keyboards described herein generally may be either graphical keyboards or printed keyboards, except for those graphical keyboards that programmatically change in appearance.

Another aspect is directed towards the use of additional gestures to allow a single displayed key to represent multiple characters, e.g., three or four. As used herein, “character” refers to anything that may be entered into a system via a key, including alphabetic characters, numeric characters, symbols, special characters, and commands. For example, a key may display one character for a “tap” input, and three characters for three differentiated upward gestures, namely one for a generally upward-left gesture, one for a generally straight up gesture, and one for a generally upward-right gesture.

Another aspect is directed towards providing a virtual touchpad or the like that facilitates text editing. A gesture may be used to invoke the virtual touchpad and enter an editing mode. The gesture may be the same as another, existing gesture, with the two similar/like gestures distinguished by their starting locations on the keyboard, or gestures that cross the surface boundary (bezel) for example.

It should be understood that any of the examples herein are non-limiting. For instance, the keyboards and gestures exemplified herein are only for purposes of illustration; other keys made redundant by other gestures may be removed, and/or not all those shown herein need be removed. Different keyboard layouts—or different device dimensions, physical form factors, and/or device usage postures or grips, in addition to those exemplified herein—will benefit from the technology described herein. Different gestures other than and/or in addition to one or more of those exemplified also may be used; further, the gestures may be “air” gestures, not necessarily on a touch-sensitive surface, such as sensed by a Kinect™ device or the like. As another example, finger input is generally described, however a mechanical intermediary such as a plastic stick/stylus or a capacitive pen that is basically indistinguishable from a finger, or a battery-powered or inductively coupled stylus that can be distinguished from the finger are some of the possible alternatives that may be used; moreover the input may be refined, (e.g., hover feedback may be received for the gestural commands superimposed on the keys), and/or different length and/or accuracy constraints may be applied on the stroke gesture depending on whether a pen or finger is known to be performing the interaction (which may be detected by contact area). As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computers and keyboard and gesture technology in general.

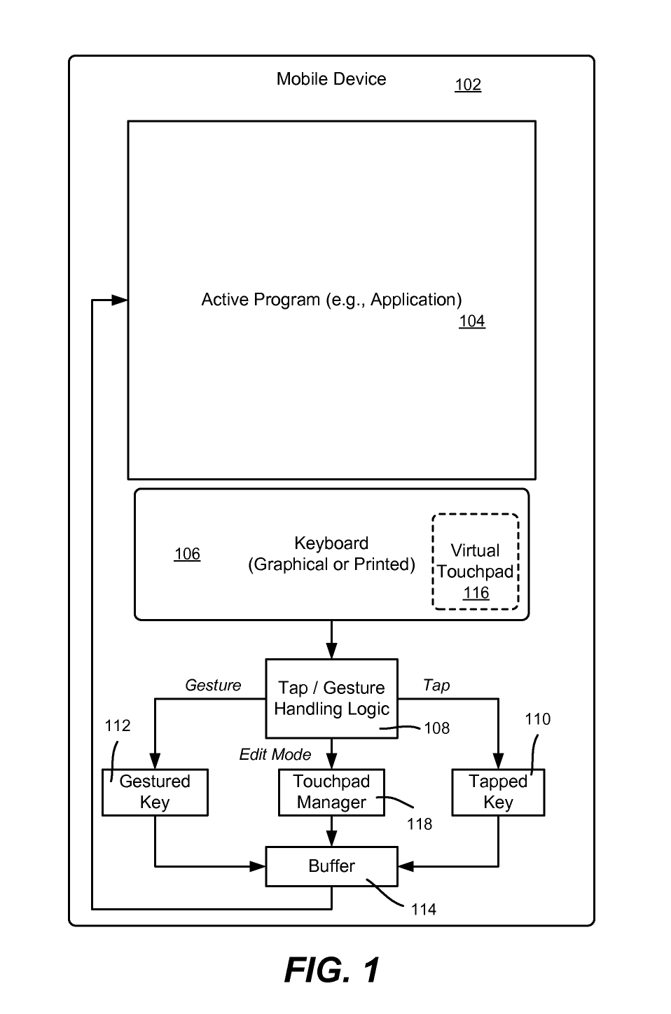

FIG. 1 shows a block diagram in which a mobile device 102 runs an active program 104 for which a graphical or printed keyboard 106 is presented to facilitate user input. Note that the program 104 and keyboard 106 may occupy all of or almost all of the entire touch-sensitive area, and thus FIG. 1 is not intended to represent any physical scale, size or orientation of the various components represented therein. The touch sensitive area may be of any type, including multi-touch and/or pen touch. The touch sensitive area may be a touch sensitive screen, or a pressure/capacitive or other sensor beneath a printed keyboard.

In general, radial, or “marking” menus provide for conventional tapping on the keyboard 106 to be augmented by the use of gestures, such as simple strokes (comprising detected finger or pen movement in one general direction), received in the same area. Typically taps versus strokes may be distinguished by a minimum time of finger or stylus contact and/or a threshold on a total distance moved by the finger or other input mechanism (e.g., stylus). This is generally because “taps” may inadvertently slide a little bit, and thus very short strokes are treated as taps in one implementation. Further, long strokes may return to (near) the starting point. This reverse gesture may be used as a way to “cancel” a stroke gesture in progress in one implementation, before the finger or other input mechanism is lifted. In this situation, no input to the buffer occurs (i.e. these are neither taps nor gestures). Similarly, a user may initiate a shift with a gesture up on a key and decide to not used the shifted key; the user may stroke downward around the initial position of the touch (e.g., without having lifted the finger) and then release the finger. This reverse gesture may output the lowercase character; note that the current state displayed on the key may reflect the state (e.g., to show a shifted character when the finger is above the key beyond a certain threshold, and the lowercase character when the finger is close to the initial position).

In one implementation, tapping on any alphabetic key of the keyboard 106 outputs the lower-case character associated with that key, whereas an upward stroke initiated on the same key results in the shifted value (e.g., uppercase) of the associated character being output, thus avoiding the need for a separate tap on a Shift key. A stroke to the right initiated anywhere on the keyboard 106 outputs a Space. Likewise, a stroke to the left, initiated anywhere on the keyboard 106 outputs a Backspace, while one slanting down to the left (e.g., initiated anywhere on the keyboard 106) outputs Enter. In some embodiments, the standard stroke gestures are enabled on the central cluster of alphanumeric characters, whereas one or more peripheral keys (e.g. specific keys, such as backspace or Ctrl, or specific regions, such as a numeric keypad or touch-pad area for cursor control (if any), may have different or just partially overlapping stroke gestures assigned to them, including no gestures at all, e.g. in the case of cursor control from a touchpad starting region as exemplified below). Thus, the stroke menus may be spatially multiplexed (e.g., potentially different from some keys, or for certain sets of keys). Also, keys near the keyboard edge, where gestures in certain directions may not be possible due to lack of space (e.g. a right stroke from a key on the right edge of the surface), whereby the user may start a gesture more from the center to enter the input.

Note that gestures also may be used to input other non-character actions (not only backspace), such as user interface commands in general (e.g., Prev/Next fields in form-filling, Go commands, Search commands, and so forth) which sometimes have representations on soft keyboards. Still further, richer or more general commands (such as Cut/Copy/Paste) may also be entered by gestures, macros may be invoked by gestures, and so forth.

To this end, as shown in FIG. 1, tap/gesture handling logic 108 determines what key was tapped (block 110) or what key (e.g., shift of a character, space, backspace or enter) was intended to be entered via a gesture (block 112). The character's code is then entered into a buffer 114 for consumption by the active program 104.

Note that gestures are generally based upon North-South-East-West (NSEW) directions of the displayed keyboard. However, the NSEW axis may be rotated an amount (in opposite, mirrored directions), particularly for thumb-based gestures, because users intending to gesture up with the right thumb actually tend to gesture more NE or NNE; similarly the left thumb tends to gesture more NW or NNW.

Further, as described herein, the tap or gesture handling logic 108 provides a user with a mechanism for entering an edit mode in which a virtual editing touchpad 116 or the like is made available to the user, along with a mechanism for exiting the edit mode. As also described herein, taps, movements and gestures on the virtual editing touchpad 116 are handled by a touchpad manager 118 and may result in character values and/or pointer events entered into the buffer 114. Note that in another implementation, a touchpad is always visible (at least for one associated keyboard), and there is no need to switch modes.

Because of the ability to use gestures for certain keys, those keys become unnecessary/otherwise redundant for entering their corresponding characters. Described herein is the removal of those keys from the keyboard, thus providing a number of benefits.

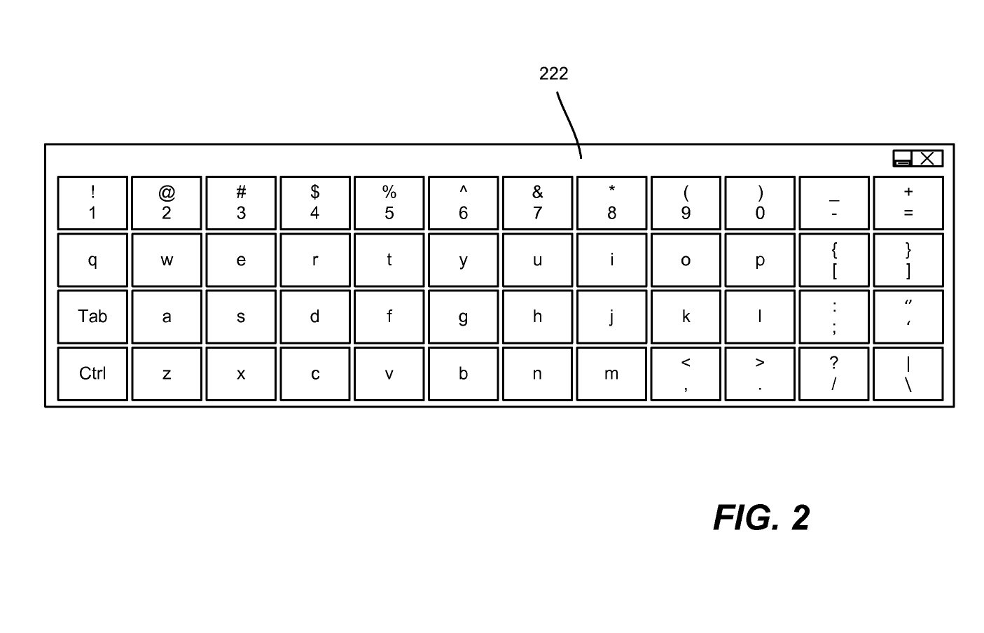

FIG. 2 shows a tap-plus-stroke QWERTY graphical or printed keyboard 222 with removed Space, Backspace, Shift and Enter keys. (Note that an alternative to actual complete removal/elimination is to have one or more keys significantly reduced in size and/or combined onto a single key, that is, substantial removal of those keys. Likewise, this may refer to a standard keyboard (with all keys) being available as on tab or option, and a keyboard with some or all of these keys removed being another tab or option, per user preference. As used herein, “remove” and its variants such as “removal” or “removing” refer to actual removal or substantial removal.)

As can be seen, via the removal, numerical/special characters may be substituted, e.g., the top row of the standard QWERTY keyboard (the digits one through nine and zero, as well as the shifted characters above them) is provided in the space freed up by removing the redundant keys. In one implementation, employing the uppercase and lowercase symbols of the added keys moves a total of twenty-six characters to the primary keyboard from a secondary one. Note that other characters that appear on a physical QWERTY keyboard also appear to the right and lower left. By removing the Space, Enter, Shift and Backspace keys, this keyboard provides far more characters while consuming the same touch-sensitive surface real estate and having the same size of keys, for example, as other keyboards with far less characters. The immediate access to those common characters that this mechanism provides produces a very significant increase in text entry speed, and reduces complexity.

The increase in entry speed may be accomplished without changing the size of the keys or the amount of real-estate consumed by the keyboard. Furthermore, the technology reduces or even eliminates the frequency of shifting from one graphical keyboard to another, while building on existing user skills rather than requiring a significant user investment in learning new ones. Users may start to benefit virtually immediately.

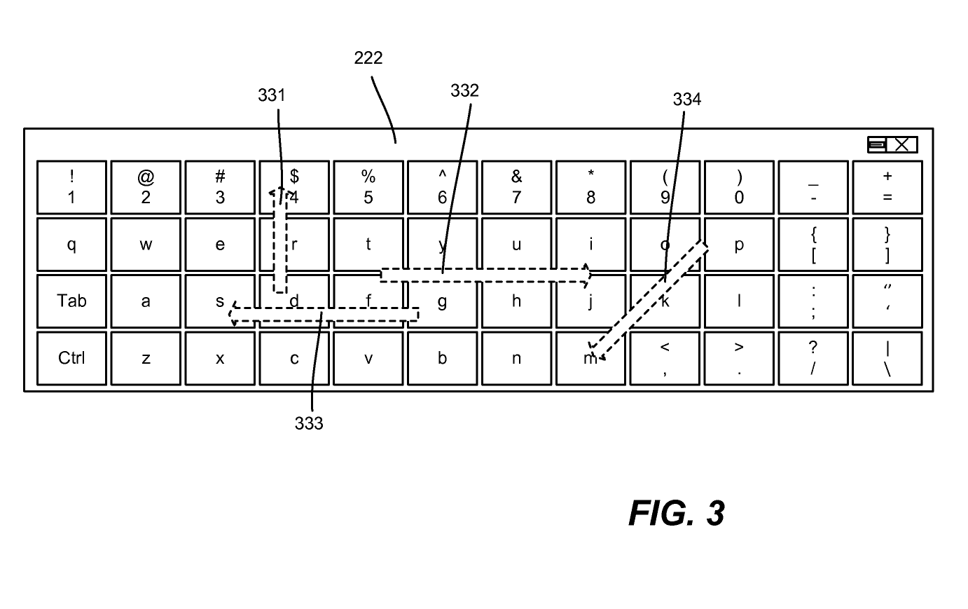

FIG. 3 is a representation of how the exemplified tap-plus-stroke graphical or printed keyboard 222 works, with dashed arrows representing possible user gestures. Note that more elaborate gestures may be detected and used, however gestures in the form of simple strokes suffice, and are intuitive and easy for users to remember once learned. In some embodiments, the length of the stroke may also be taken into account (e.g. a very short stroke is treated as a tap, a normal length stroke to the left is treated as Backspace, and a longer stroke to the left is treated as a Delete Previous Word or Select Previous Word command.

In FIG. 3, any key that is tapped (contacted and lifted off) behaves like any other touch keyboard. That is, tapping gives the character or function (typically indicated by the symbol represented on the displayed key) of the key tapped. Thus, on this keyboard, if the “a” key is tapped, a lower-case “a” results.

In another embodiment, a gesture may be used to initiate an action, with a holding action after initiation being used to enter a control state. For example, a stroke left when lifted may be recognized as a backspace, whereas the same stroke, but followed by holding the end position of the stroke instead of lifting, initiates an auto-repeat backspace. Moving left after this point may be used to speed up auto-repeat. Moving right may be used to slow down the auto-repeat, and potentially reverse the auto-repeat to replace deleted characters.

The arrow labeled 331 shows how an upward stroke gesture is processed into a shift version of the character. That is, instead of the user tapping, if the user does an upward stroke, the shifted version of that character results. In the example of FIG. 3, if the “d” key is contacted followed by an upward stroke (instead of a direct lifting of the finger or stylus) as indicated by arrow 331, an uppercase “D” results.

Note that in an alternative embodiment, (or in the same implementation but from a certain starting area), a generic upward gesture may be used to engage a shift state for the entire keyboard (rather than requiring a targeted gesture to produce the shift character). This helps with edge gesture detection where users need to gesture from the bottom row of keys (which may inadvertently invoke other functionality). Also, an upward gesture with two fingers instead of one (and initiated anywhere on the keyboard) may cause a Caps Lock instead of Shift (and a downward gesture with two fingers down may restore the default state). Instead of a two-finger gesture, a single finger gesture made while another finger is pressing on the keyboard may be interpreted to have a different meaning from a similar single-finger gesture.

In one example implementation, if a user touches anywhere on the keyboard and does a stroke to the right, a Space character results. This is illustrated by arrow 332 in FIG. 3. A left stroke represents a Backspace; that is, if the user touches anywhere on the keyboard and does a stroke to the left, he or she indicates a Backspace, which thereby deletes any previous character entered. This is illustrated by arrow 333 in FIG. 3. A downward-left stroke provides an Enter (or Return) entry; that is, it the user touches anywhere on the keyboard and does a downward stroke to the left, an “Enter” key results, as represented by the arrow 334. Threshold angles and the like can be used to differentiate user intent, e.g., to differentiate whether a leftward and only slightly downward stroke is more likely a Backspace or an Enter stroke. In one implementation, for some or all of the gestures, the user can release outside of the displayed keyboard as long as the gesture was initiated inside the keyboard.

Note that because the SPACE, BACKSPACE and ENTER strokes can be initiated anywhere on the keyboard, which is a large target, and that their direction is both easy to articulate and has strong mnemonic value, they can be articulated using an open-loop ballistic action (ballistic gestures not requiring any fine motor control), rather than a closed-loop attentive key press. The result is an easy-to-learn way to significantly increase text entry rates. Thus, also described herein is improving the overall performance of entering alphanumeric text with a keyboard. The technique achieves improvements by significantly reducing the number of keystrokes required to enter almost any character string, and also significantly reduces the need to move back-and-forth between the primary QWERTY keyboard and secondary keyboards with special characters. Avoiding switching keyboards not only increases performance because there is no need to tap on a dedicated key, but also because it avoids the visual parsing of the keyboard layout for every switch. The size of the QWERTY keyboard may be unchanged, as may be the size of the keys.

Furthermore, the technique is designed to build upon existing skills, such as familiarity with the QWERTY layout. The technique is easily discoverable, can be learned in easily, and unlike other techniques, (which can enable far faster speeds than the technique proposed, but only for relatively very few users), this technique benefits users almost immediately. Example ways to facilitate discovery are described in U.S. Pat. No. 8,196,042, and U.S. published patent applications nos. 20090187824 and 20120240043. Such assistance may illustrate the gestures, as well as particular manual strategies for articulating them, such as entering the space (right stroke) with the left thumb, and the backspace (left stroke) with the right thumb, which has been found to encourage an efficient typing rhythm.

Thus, the technology described herein increases text entry speed, and unlike previous implementations, makes the new gesture technique very discoverable. As described herein, keys from the keyboard that are made redundant by the strokes are removed. Doing so enables freeing up valuable screen or surface real-estate used for other keys, e.g., by removing an entire row from the keyboard. However, what remains is still immediately recognizable as a QWERTY keyboard. Any missing keys are quickly noticed as soon as one wants to use them, which facilitates discoverability of the new technique. For example, via a HELP key/HELP key combination/HELP gesture or other referenced ways to facilitate discovery, the gestures (e.g., single strokes) are explained are almost immediately remembered, thereby enabling the user to use the keyboard productively. Further, context may be used to explain the gestures; for example, if the system knows that a user has never used the new keyboard and there is a long pause before an expected space character, the system may conclude that the user is most likely looking for the space key, thus triggering a visual explanation for the space gesture, (and possibly explaining other available gestures too at the same time).

Turning to aspects of reducing key count and/or menu count, the technology described herein also may eliminate duplicated keys, as there are some characters that conventionally appear on more than one keyboard. For example, the ten digits often appear on multiple numeric keyboards, as do the period “.” and comma “,” characters. Duplicates of such keys may be eliminated. This may be used to significantly reduce the number of overall keys needed by a system, while still supporting all of the keys and functions of the current keyboard. Furthermore, in so doing, the number and/or size of any secondary, tertiary (and/or other) keyboards may be reduced, or the secondary, tertiary (and/or other) keyboards may be eliminated because they are no longer necessary.

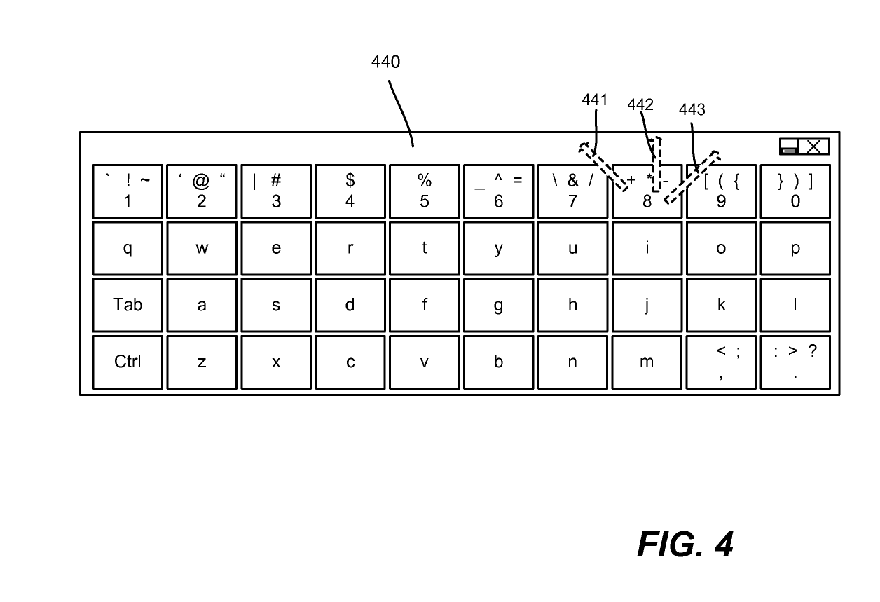

FIG. 4 shows an implementation in which up to three, rather than one, upper-case characters (including symbols and commands or the like) are added to the certain keys of a keyboard 440, resulting in up to four characters per key; (note that the example reduced keyboard of FIG. 4 has only ten columns, which may make it more appropriate for portrait mode input). For example, the three upward strokes, North-West (arrow 441), North (arrow 442), and North-East (arrow 443) may be used to distinguish among which of the three upper-case characters is selected. The North character (e.g., the asterisk “*”) may be the character normally coupled with the associated lower-case character on standard QWERTY keyboards, and is displayed as positioned between the other two stroke-shifted characters. Hence, the general direction of the upward stroke corresponds to the position of the character selected, (with North-West stroke selecting the left stroke-shifted character plus “ ”+”, and North-East the right stroke-shifted character minus “−”). Note that in this example some keys such as the “4” key still have room for one or two more characters. In other implementations, there may be more gestures per key (thus having more characters per key), and/or more gestures that can be initiated anywhere on the keyboard.

Note that two (or more) simultaneous finger gestures may be used with such a three (or more) character key. This may be used to enter commands, or provide for even more than three or more characters per key than a single finger gesture.

By this technique, all shifted characters are accessible, yet a secondary keyboard that would otherwise provide such characters may be eliminated (which is also true of the example keyboards of FIGS. 2 and 3). This provides full access to an entire character set from one keyboard (other than the emoticons, which may have a secondary keyboard, such as invoked from an icon represented on one of the unused North-West or North-East locations, and/or be invoked via a gesture). Note that even the emoticons may be typed in the traditional manner from the base keyboard.

In summary, a hybrid tap/stroke keyboard is provided which augments a QWERTY tap keyboard with gestures (e.g., strokes) that provide alternatives for the frequently used Space, Backspace, Shift, and Enter keys. The keys made redundant by the strokes are removed from the keyboard. This frees up surface real estate, e.g., a whole row, into which the set of numbers and special characters or the like may appear on the primary keyboard, without impacting key size or overall keyboard footprint. Different upward strokes provide for an even richer character set.

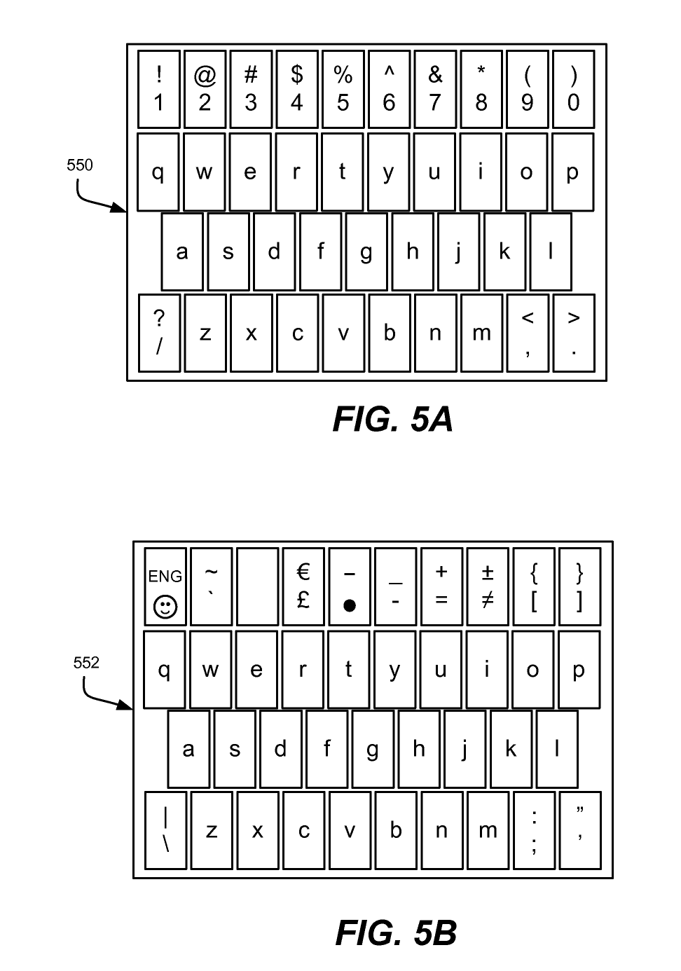

FIG. 5A shows a similar concept of removing keys from a primary QWERTY keyboard on mobile phone-type graphical keyboards 550 (in contrast to the graphical or printed tablet/slate-style keyboards of FIGS. 2-4). FIG. 5A has the same footprint as other mobile phone keyboards, while preserving the standard QWERTY layout, but the three alphanumeric rows have been shifted down one row via removal of the SHIFT, BACKSPACE, SPACE and ENTER keys. Note that other function keys that previously may have been provided in the bottom row (e.g., “&!@#” menu key, emoticon key, and En language key) have also been removed. Their functionality is reintroduced in the top row as described herein.

Having created space by eliminating keys, the ten vacant keys in the top row may be populated in a manner consistent with the top row of the standard QWERTY Keyboard, with the ten digits in the lower-case positions, and the usual characters occupying the upper case positions. Likewise, the three unused keys in the bottom row may be populated with the six characters (three upper-case and three lower-case) typically found in the bottom row of a standard QWERTY keyboard. As with the general shift character concept described above, for alphabetic characters tapping outputs the lower-case character, while an upward stroke starting on a particular key outputs the associated shifted (e.g., uppercase) character.

By the removal of keys made redundant by gestures in this example graphical keyboard, twenty-six new characters are added that are directly accessible from the main keyboard. In so doing, the standard layout of the traditional QWERTY keyboard is basically retained, thereby reducing problems of visual search for users familiar with the standard layout and significantly reducing the frequency with which users have to go to a secondary keyboard in order to type a message. Furthermore, the more efficient gestural means of articulating the SHIFT, SPACE, BACKSPACE and ENTER keys are integrated.

To accommodate other characters, one way to accomplish this is to add a second graphical keyboard, such as is done in contemporary phone implementations. However, rather than a whole new graphical keyboard, in one implementation only selected keys may change (e.g., FIG. 5B). For example, the core alphabetic keys may remain accessible. A user may toggle between the two graphical keyboards in one or more various ways, such as by a ballistic gesture starting anywhere on the keyboard, e.g., a stroke up to the left (North-West).

FIG. 5B shows one implementation of such a partial secondary graphical keyboard 552. Note that only certain keys change relative to FIG. 5A, as the alphabetic keys remain in place. Further, note that in FIG. 5B, the third key in from the right in the top row (“±” and “≠”) provides two characters not typically supported by contemporary phones, and the blank key (third key in from the left in the top row) leaves room for two additional characters.

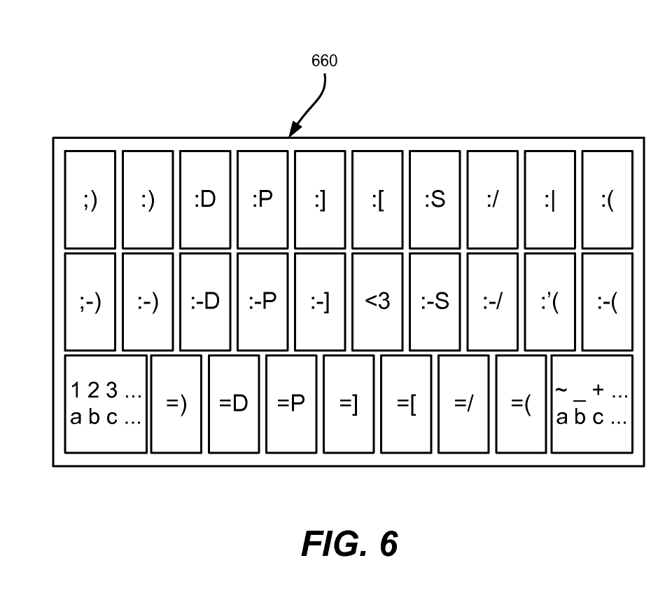

An emoticon keyboard, such as the example graphical emoticon keyboard 660 of FIG. 6, may be invoked from any suitable key location, such as the lower-case option on the top-left key on the secondary keyboard in FIG. 5B and/or by a dedicated gesture. Once the desired emoticons are entered, the user can return directly to either the primary keyboard (bottom left corner key) or the secondary keyboard (bottom right corner key), for example.

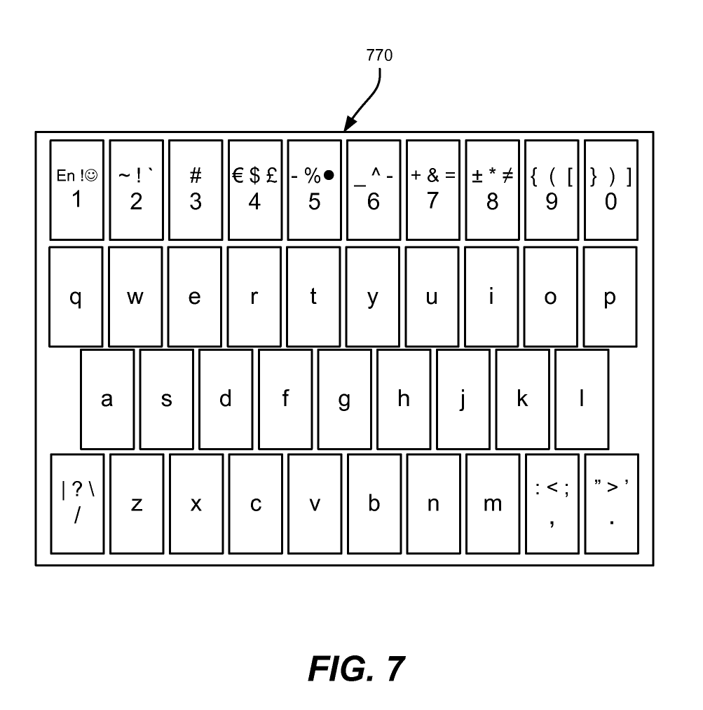

Note that as in the tablet (or slate) style keyboard of FIG. 4, the number of keys needed on a phone style keyboard may be similarly reduced by having more than two characters per key maximum. This is represented in the graphical (or printed) keyboard 770 of FIG. 7, where keys on the top row, and certain ones on the bottom row, may use North-West, North, and North-East strokes to differentiate between available characters.

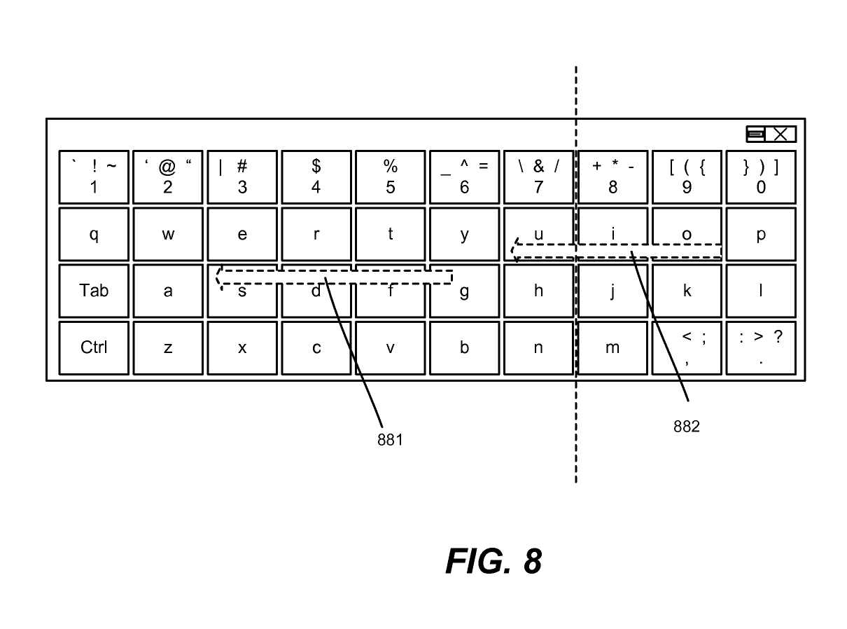

Turning to aspects related to editing, described herein is a virtual touchpad, which may include cursor keys and/or be used to enter pointer events, for example. FIG. 8 shows how a keyboard may be separated into different regions in which gestures made therein are assigned different meanings depending on the region in which the gesture started (and/or possibly ended). For example, keys and/or the key background to the right of the dashed line (the dashed line is only for explanation herein, and is not actually visible to users) may be displayed in a way that is visibly different in some way (e.g., shaded or colored) relative to those keys and/or their background to the left of the dashed line.

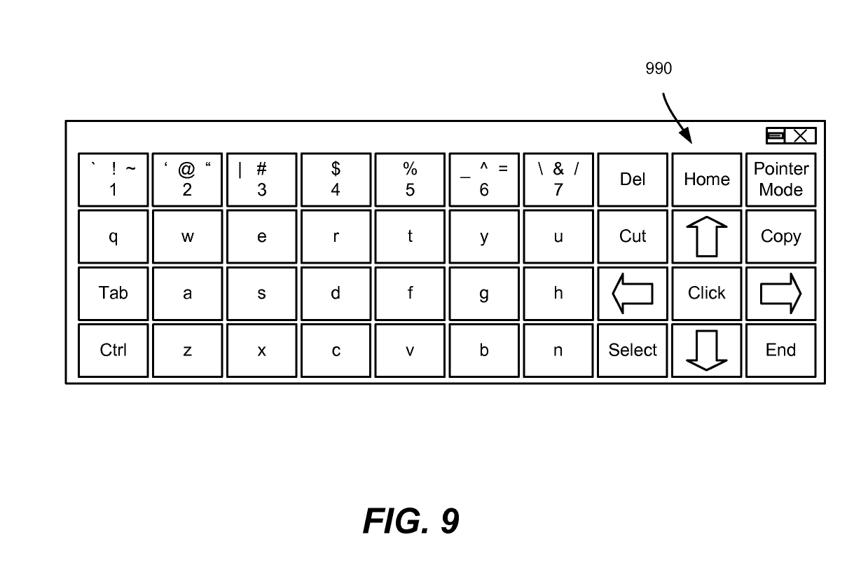

Then, for example, a left stroke 881 in the region to the left of the dashed line is still a Backspace. However, instead of a right-to-left stroke anywhere on the graphical keyboard always being a Backspace, spatial multiplexing may be used, e.g., the same gesture 882 starting in the region/keys to the right of the dashed line may instead have a different meaning. For example, on a graphical keyboard, such a gesture to the right of the dashed line may bring up a virtual touchpad (cursor mode) 990, as generally represented in FIG. 9. Note that the screen real estate consumed by the keyboard is not increased in this example.

As can be readily appreciated, this is only one example, and alternatively a different gesture (e.g., a stroke straight down) or more elaborate gesture (e.g., a circular or zigzag gesture, or a gesture with two or more fingers) may be used to bring up the virtual touchpad without having different regions. Stroking on the keyboard with two fingers in contact offers another example, which, for example, may eliminate the intermediate step of bringing up the virtual touchpad; (e.g., a two-finger movement, or movement with one finger held down while the other finger or a stylus enters a gesture may be directly interpreted as a cursor mode input). Another gesture (possibly the same one) or interaction with another part of the keyboard may be used to remove the virtual touchpad (cursor mode) 990 to resume typing.

The keys shown in the virtual touchpad (cursor mode) 990 are only examples of one possible implementation, with cursor, home and end keys allowing for cursor movement. A Select key may toggle between a cursor movement mode and a mode in which text is highlighted for selection as the user moves over it via the cursor keys, for example.

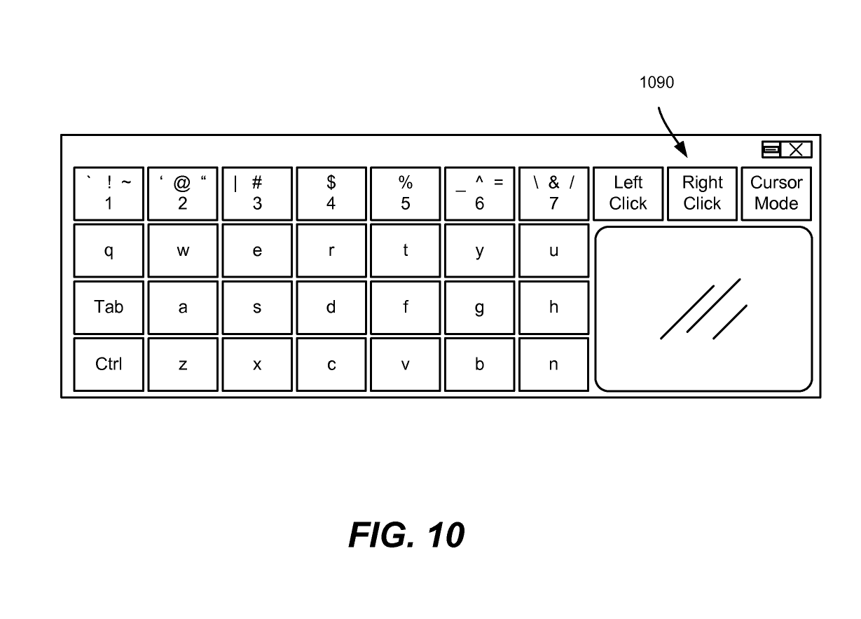

A Pointer Mode key may be used to toggle from the virtual touchpad cursor mode into which a user enters pointer events by dragging a finger or stylus, tapping, double-tapping and so forth as with existing touchpad mechanisms. One such virtual touchpad pointer mode 1090 is exemplified in FIG. 10. Note that in another instance, there is no need for an explicit pointer mode, e.g., when the user initiates the gesture from a specific location or key, the user can control the cursor.

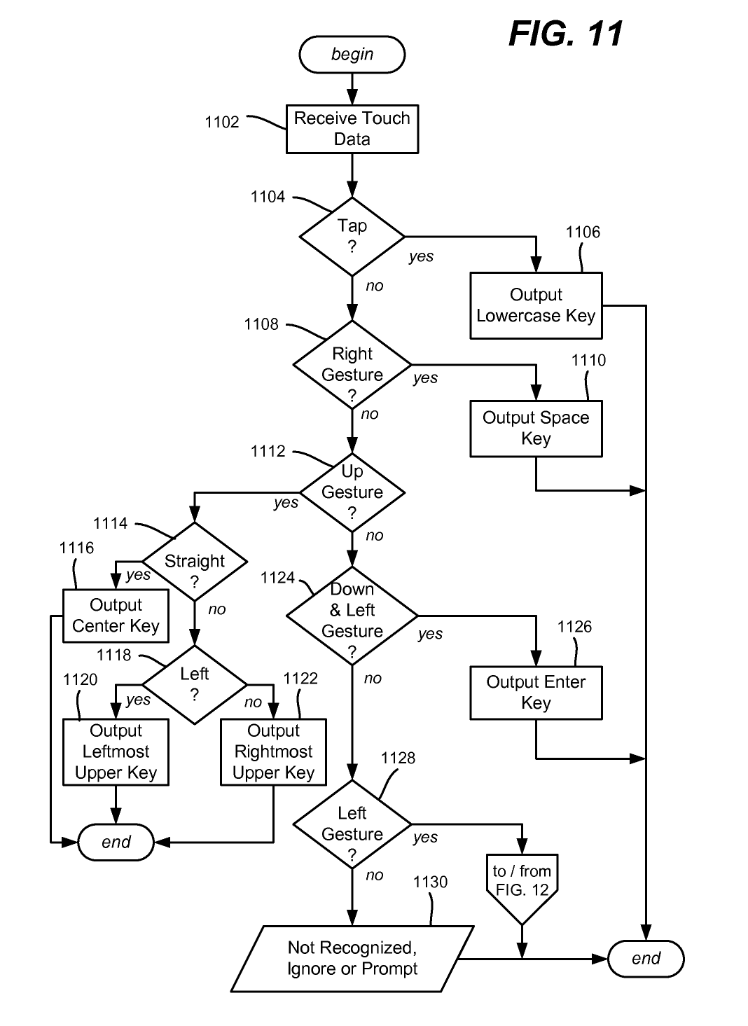

FIG. 11 is an example flow diagram summarizing some example steps of one implementation of tap/gesture handling logic 108 (FIG. 1). As is understood, these steps need not be in the order exemplified, and this is only an example. The steps of FIG. 11 begin at step 1102 where some touch and/or stylus data is received. If a tap as evaluated at step 1104, the lowercase (un-shifted) tap-related character value is output at step 1106. Steps 1108 and 1110 represent handling a right gesture/space character.

In this example implementation, more than two characters may be available on a given key, with the selected one corresponding to up-left, up, and up-right gestures. Thus, if a generally upward gesture is detected at step 1112, steps 1114 and 1116 handle such a straight-up gesture by outputting the center key's character value (of the shifted key). Steps 1118 and 1120 output the leftmost upper key's character value (of the shifted key), and step 1122 outputs the rightmost upper key's character value (of the shifted key). Note that rather than left, “leftmost” is exemplified because not all keys need have a left character, and similarly “rightmost” is used for the same reason. For example, in FIG. 4, the leftmost character for the shifted “3” key is the vertical line “|” character, but the rightmost character is the same as the straight-up character “#” in this example. For the shifted “4” key, the “$” is the leftmost, straight-up and rightmost character available. Note that in another instance, if a direction has no corresponding character (e.g. up-right shifted character value of the “3” key), a gesture toward that direction will not select a character to avoid unintentional selection.

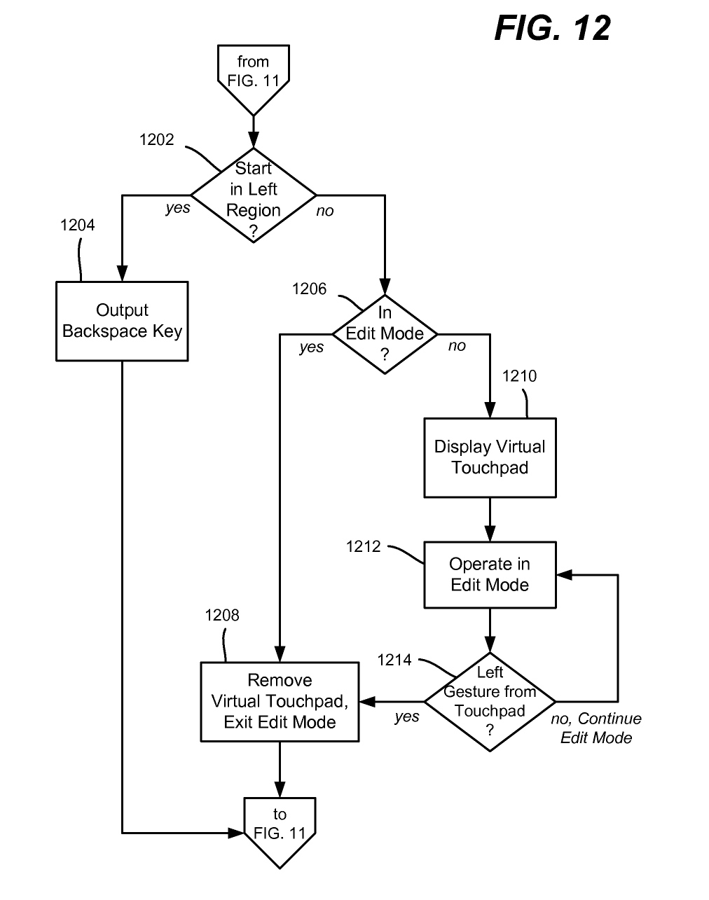

Steps 1124 and 1126 handle the output of the Enter character. Step 1128 detects a left gesture for handling as generally shown in FIG. 12. An unrecognized gesture may be dealt with (step 1130) by ignoring it or prompting the user with a help screen, or used for other purposes, and so on.

FIG. 12 shows how a left stroke is handled in an implementation such as in FIG. 8 where a keyboard has distinct starting regions for left gestures. Step 1202 represents evaluating whether the stroke started in the left region (using the example of FIG. 8). If so, the stroke results in a Backspace character being entered at step 1204. This may occur while in the editing mode, since a Backspace is highly useful in editing (as well as in regular typing).

If the left stroke started in the right region (using the example of FIG. 8), the current mode is evaluated. If already in the editing mode, the stroke results in exiting the editing mode, including removing the virtual touchpad, at step 1208. Note that if in pointer mode as represented in FIG. 10, the stroke will have to clearly exit the pointer-entry region to be considered an exit command, so as to differentiate it from pointer entry to move the cursor or highlight text, for example.

If not in the editing mode at step 1206, step 1210 enters the editing mode, including by displaying the virtual touchpad. Step 1212 represents operating in the editing mode, including its cursor key sub-mode and pointer sub-mode, (as well as possibly one or more other sub-modes), which continues until a user exits the mode via a left gesture at step 1214. Again, the stroke may clearly have to exit the virtual touchpad area, particularly if the user is in the pointer entry sub-mode. In another instance, if the virtual touchpad is large enough to have the editing mode and pointer mode on it together, thus there is no need to have a sub-mode because the editing mode and pointer sub-mode are visible at the same time.

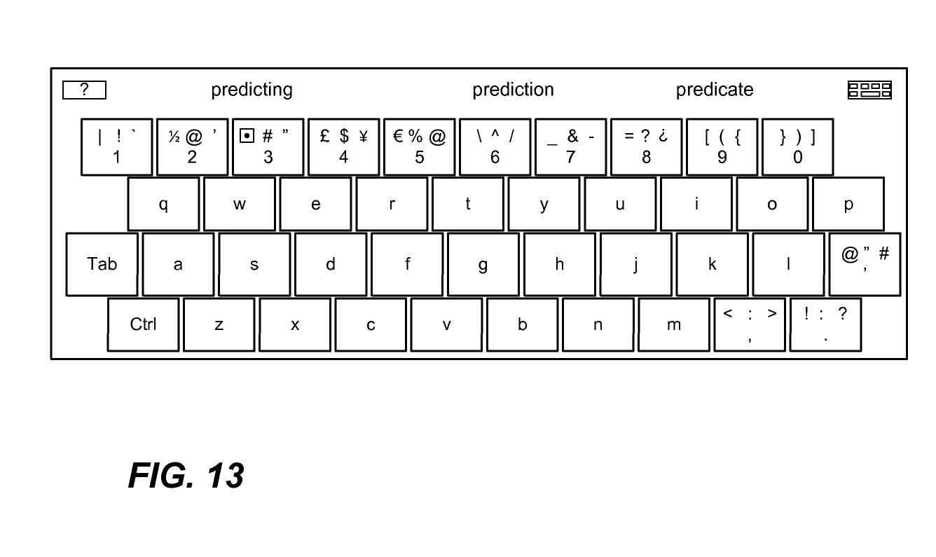

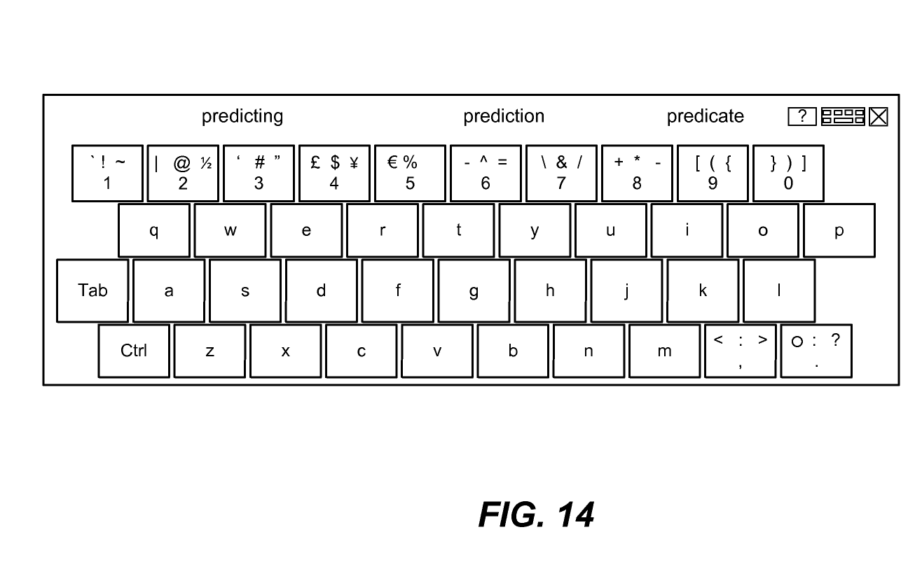

FIGS. 13 and 14 show alternative keyboards, including staggered key arrangements that also illustrate where word predictions may be shown (e.g., above the top row). In addition, they include a more nuanced consideration of the shift key layout (e.g., as demonstrated in the example numeric keys and the “,” and “.” keys in the bottom right). Note that although not explicitly shown in the line drawings, colors and shades may be used, e.g., a medium gray for the SHIFT characters, and closer to a true white for the numbers themselves, which places visual attention on the primary characters (e.g., the numbers) while implicitly deemphasizing the symbols available from the shift gestures, yet still having them visible clearly in a single view.

As can be seen, there is shown implementations of graphical and/or printed keyboards that provide access to more of the character set than other known keyboards. At the same time, the real-estate footprint of the keyboard may remain unchanged, and/or the footprint can be reduced. The key size may remain constant. Further, not only is time saved by not having to navigate between character sets, typing speed tends to increase due to using directional stroke gestures for Space, Backspace, Shift, and Enter, including that Space, Backspace and Shift may be entered without having to look at the keyboard. A standard QWERTY keyboard layout may be used, in which event users will recognize the keyboard when they encounter it. Similar situations exist for keyboards of other countries/character sets.

Unlike prior keyboards, the otherwise redundant keys are removed from the layout, whereby discovering the gestures is inherent. For example this frees up a row on the keyboard, whereby the numeric, punctuation and special characters typically on one or more secondary keyboards fit into the resulting freed up space.

### Example Operating Environment

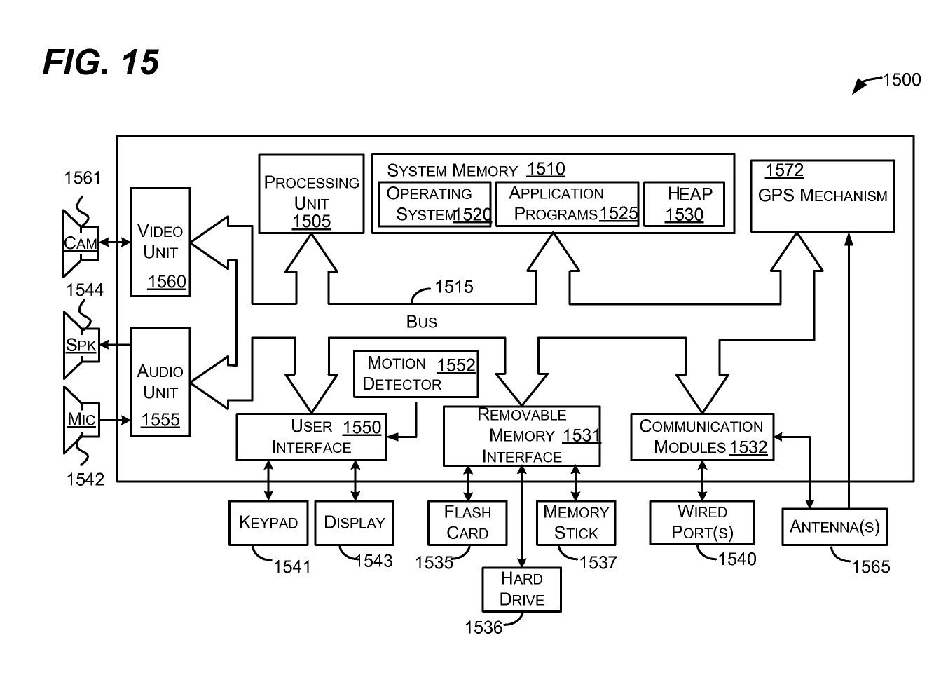

FIG. 15 illustrates an example of a suitable device 1500, such as a mobile device, on which aspects of the subject matter described herein may be implemented. The device 1500 is only one example of a device and is not intended to suggest any limitation as to the scope of use or functionality of aspects of the subject matter described herein. Neither should the device 1500 be interpreted as having any dependency or requirement relating to any one or combination of components illustrated in the example device 1500.

With reference to FIG. 15, an example device for implementing aspects of the subject matter described herein includes a device 1500. In some embodiments, the device 1500 comprises a cell phone, a handheld device that allows voice communications with others, some other voice communications device, or the like. In these embodiments, the device 1500 may be equipped with a camera for taking pictures, although this may not be required in other embodiments. In other embodiments, the device 1500 may comprise a personal digital assistant (PDA), hand-held gaming device, notebook computer, printer, appliance including a set-top, media center, personal computer, or other appliance, other mobile devices, or the like. In yet other embodiments, the device 1500 may comprise devices that are generally considered non-mobile such as personal computers, computer with large displays (tabletop and/or wall mounted displays and/or titled displays), servers or the like.

Components of the device 1500 may include, but are not limited to, a processing unit 1505, system memory 1510, and a bus 1515 that couples various system components including the system memory 1510 to the processing unit 1505. The bus 1515 may include any of several types of bus structures including a memory bus, memory controller, a peripheral bus, and a local bus using any of a variety of bus architectures, and the like. The bus 1515 allows data to be transmitted between various components of the mobile device 1500.

The mobile device 1500 may include a variety of computer-readable media. Computer-readable media can be any available media that can be accessed by the mobile device 1500 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 1500.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, Wi-Fi, WiMAX, and other wireless media. Combinations of any of the above should also be included within the scope of computer-readable media.

The system memory 1510 includes computer storage media in the form of volatile and/or nonvolatile memory and may include read only memory (ROM) and random access memory (RAM). On a mobile device such as a cell phone, operating system code 1520 is sometimes included in ROM although, in other embodiments, this is not required. Similarly, application programs 1525 are often placed in RAM although again, in other embodiments, application programs may be placed in ROM or in other computer-readable memory. The heap 1530 provides memory for state associated with the operating system 1520 and the application programs 1525. For example, the operating system 1520 and application programs 1525 may store variables and data structures in the heap 1530 during their operations.

The mobile device 1500 may also include other removable/non-removable, volatile/nonvolatile memory. By way of example, FIG. 15 illustrates a flash card 1535, a hard disk drive 1536, and a memory stick 1537. The hard disk drive 1536 may be miniaturized to fit in a memory slot, for example. The mobile device 1500 may interface with these types of non-volatile removable memory via a removable memory interface 1531, or may be connected via a universal serial bus (USB), IEEE 15394, one or more of the wired port(s) 1540, or antenna(s) 1565. In these embodiments, the removable memory devices 1535-1537 may interface with the mobile device via the communications module(s) 1532. In some embodiments, not all of these types of memory may be included on a single mobile device. In other embodiments, one or more of these and other types of removable memory may be included on a single mobile device.

In some embodiments, the hard disk drive 1536 may be connected in such a way as to be more permanently attached to the mobile device 1500. For example, the hard disk drive 1536 may be connected to an interface such as parallel advanced technology attachment (PATA), serial advanced technology attachment (SATA) or otherwise, which may be connected to the bus 1515. In such embodiments, removing the hard drive may involve removing a cover of the mobile device 1500 and removing screws or other fasteners that connect the hard drive 1536 to support structures within the mobile device 1500.

The removable memory devices 1535-1537 and their associated computer storage media, discussed above and illustrated in FIG. 15, provide storage of computer-readable instructions, program modules, data structures, and other data for the mobile device 1500. For example, the removable memory device or devices 1535-1537 may store images taken by the mobile device 1500, voice recordings, contact information, programs, data for the programs and so forth.

A user may enter commands and information into the mobile device 1500 through input devices such as a key pad 1541, which may be a printed keyboard, and the microphone 1542. In some embodiments, the display 1543 may be a touch-sensitive screen (or even support pen and/or touch) and may allow a user to enter commands and information thereon. The key pad 1541 and display 1543 may be connected to the processing unit 1505 through a user input interface 1550 that is coupled to the bus 1515, but may also be connected by other interface and bus structures, such as the communications module(s) 1532 and wired port(s) 1540. Motion detection 1552 can be used to determine gestures made with the device 1500.

A user may communicate with other users via speaking into the microphone 1542 and via text messages that are entered on the key pad 1541 or a touch sensitive display 1543, for example. The audio unit 1555 may provide electrical signals to drive the speaker 1544 as well as receive and digitize audio signals received from the microphone 1542.

The mobile device 1500 may include a video unit 1560 that provides signals to drive a camera 1561. The video unit 1560 may also receive images obtained by the camera 1561 and provide these images to the processing unit 1505 and/or memory included on the mobile device 1500. The images obtained by the camera 1561 may comprise video, one or more images that do not form a video, or some combination thereof.

The communication module(s) 1532 may provide signals to and receive signals from one or more antenna(s) 1565. One of the antenna(s) 1565 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 1572. In turn, the GPS mechanism 1572 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 1500 may connect to one or more remote devices. The remote devices may include a personal computer, a server, a router, a network PC, a cell phone, a media playback device, a peer device or other common network node, and typically includes many or all of the elements described above relative to the mobile device 1500.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A system comprising, a keyboard on a touch-sensitive surface at which tap input and gesture input is detected, the keyboard configured with a removed key set comprising at least one removed or substantially removed key, each key of the removed key set corresponding to a character that is enterable via a gesture.

2. The system of claim 1 further comprising logic coupled to the touch-sensitive surface to differentiate between taps and gestures.

3. The system of claim 1 wherein the removed key set comprises a removed shift key, a removed space key, a removed backspace key and a removed enter key.

4. The system of claim 1 wherein the removed key set comprises at least one of: a removed shift key, a removed space key, a removed backspace key or a removed enter key.

5. The system of claim 1 wherein the removed key set comprises a shift key, and wherein a shifted key entry is detected via a gesture initiated on a non-shifted key corresponding to the shifted key entry.

6. The system of claim 1 wherein the keyboard includes a key representing three or more characters, and wherein at least two of the characters are entered and distinguished from one another via distinct gestures initiated on the key.

7. The system of claim 1 wherein the keyboard includes a key representing at least four characters, wherein a first character of the at least four characters is entered upon detecting a tap on the key, wherein a second character of the at least four characters is entered upon detecting an up and left gesture starting on the key, wherein a third character of the at least four characters is entered upon detecting a generally straight up gesture starting on the key, and wherein a fourth character of the at least four characters is entered upon detecting an up and right gesture starting on the key.

8. The system of claim 1 wherein the keyboard is further configured to provide a virtual touchpad input area that provides a plurality of cursor keys, or a pointer input region, or both a plurality of cursor keys and a pointer input region.

9. The system of claim 1 wherein the keyboard is further configured to provide a virtual touchpad input area that provides a plurality of cursor keys in one mode, and a pointer input region in another mode.

10. The system of claim 1 wherein the gesture input surface is divided into at least two regions including a first region and a second region, and wherein a gesture, if started in a first region, is assigned a different meaning from the same gestured if started in a second region.

11. The system of claim 10 wherein the gesture, if started in the first region is assigned a meaning comprising a key entry, and if started in the second region, is assigned a meaning comprising a command relating to an edit mode.

12. The system of claim 1 wherein a gesture made with two fingers, or made with one finger while another finger is pressing on the keyboard, has a different meaning from a similar gesture made with one finger.

13. The system of claim 1 wherein a gesture may be canceled or changed by reversing the gesture.

14. The system of claim 1 wherein the keyboard is implemented on a tablet computing device or a mobile phone device.

15. A method comprising, receiving data corresponding to interaction with a key of a keyboard comprising a plurality of keys, in which the key represents at least three characters, and if the data indicates that the interaction represents a first gesture, outputting a first character value, or if the data indicates that the interaction represents a second gesture that is different from the first gesture, outputting a second character value.

16. The method of claim 15 wherein if the data indicates that the interaction represents a tap, outputting tap-related character value represented by the key.

17. The method of claim 15 wherein if the data indicates that the interaction represents a third gesture that is different from the first gesture and the second gesture, outputting a third character value.

18. One or more computer-readable media having computer-executable instructions, which when executed perform steps, comprising, providing a graphical or printed keyboard, in which the graphical or printed keyboard includes alphabetic keys and numeric keys in a same-sized or substantially same-sized screen area relative to a different graphical or printed keyboard that includes alphabetic keys and does not include numeric keys, and in which the graphical or printed keyboard and the different graphical or printed keyboard have same-sized or substantially same-sized alphabetic keys, including by removing one or more keys from the graphical or printed keyboard that are made redundant by gesture input.

19. The one or more computer-readable media of claim 18 wherein removing the one or more keys from the graphical or printed keyboard that are made redundant by gesture input comprises removing at least one of: a space key, an enter key, a shift key, or a backspace key.

20. The one or more computer-readable media of claim 18 having further computer executable instructions comprising, representing at least four characters on a single key of the graphical or printed keyboard, and outputting the first character entry, the second character entry, the third character entry or the fourth character entry, by processing tap input on the single key to differentiate the first character entry from among the at least four characters represented, or processing different gesture input starting on the single key to differentiate the second, third or fourth character entries from among the at least four characters represented.
